(19) United States
(12) Patent Application Publication
(10) Pub. No.: US 2026/0116425 A1
(43) Pub. Date: Apr. 30, 2026

(54) METHOD OF PLANNING A LANE-LEVEL PATH FOR A VEHICLE IN THE EXISTENCE OF SCENE UNCERTAINTY

(71) Applicant: GM GLOBAL TECHNOLOGY OPERATIONS LLC, Detroit, MI (US)

(72) Inventor: Rouhollah Sayed Jafari, Troy, MI (US)

(73) Assignee: GM GLOBAL TECHNOLOGY OPERATIONS LLC, Detroit, MI (US)

(21) Appl. No.: 18/925,440

(22) Filed: Oct. 24, 2024

(51) Int. Cl. B60W 60/00; B60W 30/18; G01C 21/00

(52) U.S. Cl. CPC B60W 60/0011; B60W 30/18163; G01C 21/3815; G01C 21/3833; B60W 2556/40

(57) ABSTRACT

A method of planning a lane-level path for a vehicle includes generating a plurality of potential paths for the vehicle according to a navigation goal, wherein each of the potential paths includes a sequence of lane maneuvers for the vehicle. The method also includes producing a plurality of proposed task lists for each of the plurality of potential paths based on at least one uncertainty with respect to the sequence of lane maneuvers; determining a utility factor for each of the plurality of proposed task lists; and selecting an optimal path from the plurality of potential paths and an optimal task list from the plurality of proposed task lists to thereby plan the lane-level path for the vehicle to achieve the navigation goal. A vehicle includes a plurality of wheels and an onboard controller in communication with the plurality of wheels and including an instruction set to execute the method.

### INTRODUCTION

The disclosure relates to a method of planning a lane-level path for a vehicle and to a vehicle.

Vehicles, such as automated or autonomous vehicles, may rely on a pre-generated, preprocessed high-definition map of a scene of travel for planning and executing a lane-level path toward a navigation goal. Such high-definition maps may include features such as, for example, lane geometries, lane types, lane markings, speed limits, and the like. In the absence of such high-definition maps, a vehicle planning module may be faced with uncertainty when generating a navigation plan.

### SUMMARY

A method of planning a lane-level path for a vehicle includes generating a plurality of potential paths for the vehicle according to a navigation goal, wherein each of the plurality of potential paths includes a sequence of lane maneuvers for the vehicle. The method also includes producing a plurality of proposed task lists for each of the plurality of potential paths based on at least one uncertainty with respect to the sequence of lane maneuvers. The method further includes determining a utility factor for each of the plurality of proposed task lists, and selecting an optimal path from the plurality of potential paths and an optimal task list from the plurality of proposed task lists to thereby plan the lane-level path for the vehicle to achieve the navigation goal.

In one aspect, generating the plurality of potential paths may include analyzing a scene of travel generated by the vehicle, wherein the scene of travel includes the at least one uncertainty selected from a vehicle maneuver type, a lane intersection type, and a lane edge type.

In an additional aspect, generating the plurality of potential paths may include specifying a sequence of one or more travel lanes for the vehicle configured to achieve the navigation goal.

In another aspect, producing the plurality of proposed task lists may include listing a plurality of sequential vehicle maneuvers configured to accomplish each of the plurality of potential paths.

In a further aspect, producing the plurality of proposed task lists may include assigning a probability of occurrence to each of the plurality of sequential vehicle maneuvers.

In one aspect, producing the plurality of proposed task lists may include assigning an overall probability to each of the plurality of proposed task lists based on the probability of occurrence of each of the plurality of sequential vehicle maneuvers.

In an additional aspect, the method may further include determining an expected utility for each of the plurality of potential paths based on the overall probability and the utility factor.

In another aspect, selecting the optimal path may include choosing one of the plurality of potential paths having the highest expected utility, and selecting the optimal task list may include choosing one of the plurality of proposed task lists having the highest utility factor.

In a further aspect, determining the utility factor may include considering one or more of an estimated time to complete each of the plurality of proposed task lists, a complexity of each of the plurality of proposed task lists, an estimated traffic congestion while completing each of the plurality of proposed task lists, and a risk factor associated with completing each of the plurality of proposed task lists.

In one aspect, considering the risk factor may include assessing whether the vehicle crosses a road boundary while completing each of the plurality of proposed task lists, whether the vehicle violates a traffic control device while completing each of the plurality of proposed task lists, whether the vehicle violates a turn lane while completing each of the plurality of proposed task lists, whether the vehicle reaches an end of lane while completing each of the plurality of proposed task lists, and whether the vehicle violates a lane marking while completing each of the plurality of proposed task lists.

In another embodiment, a method of planning a lane-level path for a vehicle includes developing an online map from inputs received from a plurality of on-board vehicle sensors, wherein the online map includes a scene of travel for the vehicle having at least one uncertainty selected from a vehicle maneuver type, a lane intersection type, and a lane edge type. The method also includes generating a plurality of potential paths for the vehicle according to a navigation goal, wherein each of the plurality of potential paths includes a sequence of lane maneuvers for the vehicle. In addition, the method includes producing a plurality of proposed task lists for each of the plurality of potential paths based on the at least one uncertainty, and determining a utility factor for each of the plurality of proposed task lists. The method also includes selecting an optimal path from the plurality of potential paths and an optimal task list from the plurality of proposed task lists to thereby plan the lane-level path for the vehicle to achieve the navigation goal.

In one aspect, developing the online map may include creating a scene graph from the scene of travel.

In an additional aspect, generating the plurality of potential paths may include searching the scene graph using a depth-first search algorithm.

In another aspect, producing the plurality of proposed task lists may include stepwise evaluating each of the plurality of potential paths and listing a plurality of sequential vehicle maneuvers configured to accomplish each of the plurality of potential paths.

In a further aspect, producing the plurality of proposed task lists may include listing both a viable proposed task list that enables reaching the navigation goal and a non-viable proposed task list that does not enable reaching the navigation goal.

In one aspect, determining the utility factor may include considering a risk factor associated with completing each of the plurality of proposed task lists, wherein the risk factor includes whether the vehicle crosses a road boundary while completing each of the plurality of proposed task lists, whether the vehicle violates a traffic control device while completing each of the plurality of proposed task lists, whether the vehicle violates a turn lane while completing each of the plurality of proposed task lists, whether the vehicle reaches an end of lane while completing each of the plurality of proposed task lists, and whether the vehicle violates a lane marking while completing each of the plurality of proposed task lists.

In an additional aspect, the method may further include automatedly controlling the vehicle along the lane-level path.

A vehicle includes a plurality of wheels configured to translate along a lane-level path, and a motive power source configured to drive the plurality of wheels. The vehicle also includes an onboard controller in communication with the motive power source and including an instruction set that is executable to: generate a plurality of potential paths for the vehicle according to a navigation goal, wherein each of the plurality of potential paths includes a sequence of lane maneuvers for the vehicle; produce a plurality of proposed task lists for each of the plurality of potential paths based on at least one uncertainty with respect to the sequence of lane maneuvers; determine a utility factor for each of the plurality of proposed task lists; and select an optimal path from the plurality of potential paths and an optimal task list from the plurality of proposed task lists to thereby plan the lane-level path for the vehicle to achieve the navigation goal.

In one aspect, the instruction set may include a planning module configured for planning the lane-level path to achieve the navigation goal in an existence of the at least one uncertainty without access to a high-definition map of the plurality of potential paths.

In an additional aspect, the onboard controller may be configured for automatedly controlling the motive power source.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a side view of a vehicle having an onboard controller that includes an instruction set for executing a method of planning a lane-level path for a vehicle.

FIG. 2 is a schematic illustration of the method executable by the onboard controller of FIG. 1.

FIG. 3 is a schematic illustration of another embodiment of the method of FIG. 2.

FIG. 4 is a schematic illustration of a plan view of an online map including a scene of travel generated by the vehicle of FIG. 1.

FIG. 5 is a schematic illustration of a scene graph created from the scene of travel of FIG. 4.

### DETAILED DESCRIPTION

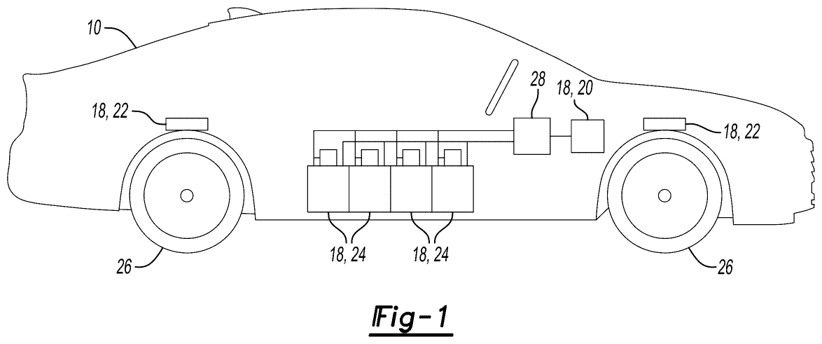

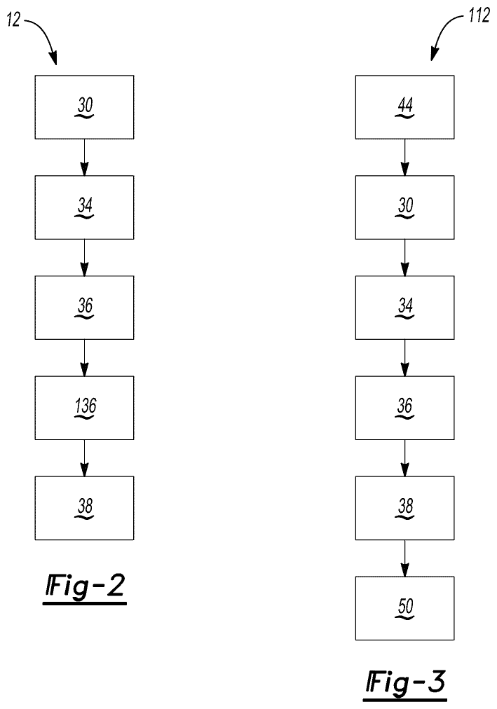

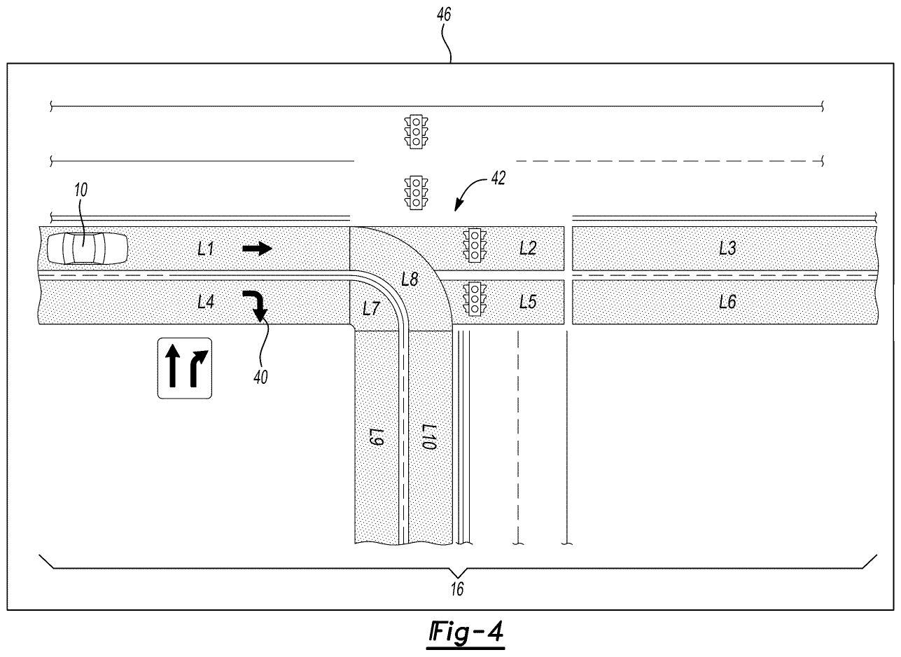

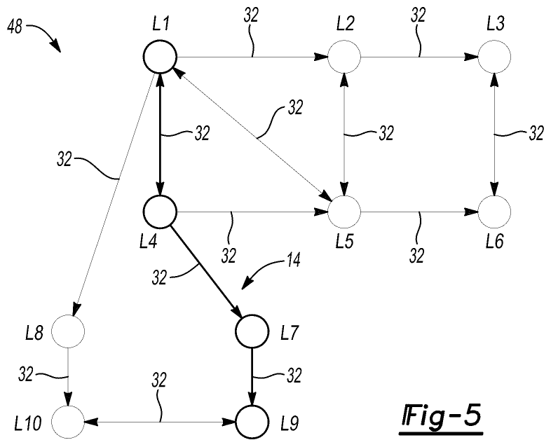

Referring to the Figures, wherein like reference numerals refer to like elements, a vehicle 10 (FIG. 1) and a method 12, 112 (FIGS. 2 and 3) of planning a lane-level path 14 (FIG. 5) for the vehicle 10 are shown generally. The method 12, 112 may be useful for applications requiring lane-level path planning for vehicles 10 without access to a high-definition map of a scene of travel 16 (FIG. 4) for the vehicle 10. For example, a high-definition map may include precise, accurate details pertaining to painted travel lane lines or markings; three-dimensional building models; signs; intersection control types; traffic signals; stop lines; lane types; lane junctures; road types for dense urban areas, commercial and retail zones, and suburban and residential areas; and stationary physical assets along highways, parking lots, garages, driveways, alleys, and the like. In the absence of one or more of these map features, path planning for a vehicle 10 may include uncertainty. However, the method 12, 112 and vehicle 10 may eliminate dependency on such high-definition maps for path planning.

More specifically, the method 12, 112 may be useful for planning the lane-level path 14 even when there is uncertainty in the scene of travel 16 with respect to, for example, travel lane geometry, topology, and attributes, as set forth in more detail below. That is, the method 12, 112 may be useful for creating an online map 46 (FIG. 4) to provide, for example, lane geometries, lane attributes, and connections between lanes, and for planning the lane-level path 14 given an uncertain environment around the vehicle 10. Therefore, and as also set forth in more detail below, the method 12, 112 may enable automated or autonomous driving in the absence of a high-definition map and in the presence of scene uncertainty.

As such, the method 12, 112 and vehicle 10 may be useful for automotive applications such as, but not limited to, internal combustion engine vehicles, electric vehicles, hybrid vehicles, and the like. For example, the vehicle 10 may be a motor vehicle powered by a motive power source 18 (FIG. 1) including at least one of an internal combustion engine 20 (FIG. 1), an electric motor 22 (FIG. 1), and an energy storage device 24.

Further, the vehicle 10 may be configured for autonomous or automated driving in which the vehicle 10 may be controlled or driven by technology including hardware and software, whether remote to the vehicle 10 or onboard the vehicle 10, that is capable of driving the vehicle 10 without active physical control by a human operator. For example, autonomous or automated driving tasks may include, but are not limited to, object and event detection, recognition, and classification; object and event response; maneuver planning; steering, turning, lane keeping, signaling, and lane changing; and acceleration and deceleration.

Alternatively, the method 12, 112 and vehicle 10 may be useful for non-automotive applications such as, but not limited to, aerospace, aviation, marine, mass transportation, agricultural, industrial, and rail applications. For example, the vehicle 10 may be, but is not limited to, a commercial vehicle, industrial vehicle, passenger vehicle, aircraft, watercraft, train, trolley, bus, or the like. It is also contemplated that the vehicle 10 may be a mobile platform, such as an airplane, all-terrain vehicle (ATV), boat, personal movement apparatus, robot, and the like to accomplish the purposes of this disclosure.

Referring now to FIG. 1, the vehicle 10 includes a plurality of wheels 26 configured to translate along the lane-level path 14 (FIG. 5). That is, the plurality of wheels 26 may be steerable and/or non-steerable wheels, and may be configured to drive or traverse along a ground surface of the lane-level path 14.

Referring again to FIG. 1, the vehicle 10 also includes the motive power source 18 configured to drive the plurality of wheels 26. In some embodiments, the motive power source 18 may include an energy storage device 24 configured to store and discharge electrical energy. For example, the energy storage device 24 may be a rechargeable, high voltage battery or battery pack. As shown in FIG. 1, the vehicle 10 may include a plurality of energy storage devices 24 electrically connected to one another to provide an output power to the vehicle 10. Further, the energy storage device 24 may be configured to provide motive power to at least one of the plurality of wheels 26. That is, in some embodiments, the vehicle 10 may be an electric vehicle 10 that receives motive power from the energy storage device 24. As such, the vehicle 10 may include one or more electric motors 22 associated with each of the plurality of wheels 26 and configured for driving the plurality of wheels 26.

In other embodiments, the motive power source 18 may include an internal combustion engine 20 that may drive the plurality of wheels 26 via a transmission (not shown), driveshaft (not shown), differential (not shown), and/or axle (not shown). Additionally or alternatively, the internal combustion engine 20 may cooperate with the energy storage device 24 to provide motive power to the plurality of wheels 26.

Referring again to FIG. 1, the vehicle 10 also includes an onboard controller 28 in communication with the motive power source 18 and including an instruction set that is executable to plan the lane-level path 14 (FIG. 5) for the vehicle 10, as set forth in more detail below. That is, the controller 28 may be onboard the vehicle 10 and may execute the method 12, 112 of planning the lane-level path 14 described below. In particular, the onboard controller 28 may include a processor configured to operate programmed code and may operate an operating system. The processor may include random access memory (RAM) and a memory storage device such as a hard drive. The onboard controller 28 may include programming to analyze data from the vehicle 10 and diagnose existence of a precursor condition of the method 12, 112.

The onboard controller 28 may be configured for automatedly or autonomously controlling 50 (FIG. 3) the motive power source 18 and vehicle 10. That is, the onboard controller 28 may include programming to take actions such as detecting, recognizing, and classifying objects and events; responding to objects and events; planning maneuvers; steering, turning, keeping lanes, signaling, and changing lanes; and accelerating and decelerating the vehicle 10 without active physical control by a human operator.

The onboard controller 28 may also include programming to take further actions regarding aspects of the method 12, 112, such as generating 30 (FIGS. 2 and 3) a plurality of potential paths 32 (FIG. 5) for the vehicle 10; producing 34 (FIGS. 2 and 3) a plurality of proposed task lists for each of the plurality of potential paths 32; determining 36 (FIGS. 2 and 3) a utility factor (u) for each of the plurality of proposed task lists; selecting 38 (FIGS. 2 and 3) an optimal path and an optimal task list to thereby plan the lane-level path 14 for the vehicle 10; ending the method 12, 112; electrically communicating with the motive power source 18 or other components of the vehicle 10; monitoring driving behavior of the vehicle 10; and the like.

More specifically, as set forth in more detail below and described with reference to FIGS. 2 and 3, the onboard controller 28 includes the instruction set that is executable to generate 30 the plurality of potential paths 32 (FIG. 5) for the vehicle 10 according to a navigation goal 40 (FIG. 4); produce 34 the plurality of proposed task lists for each of the plurality of potential paths 32 based on at least one uncertainty; determine 36 the utility factor (u) for each of the plurality of proposed task lists; and select 38 the optimal path and the optimal task list to thereby plan the lane-level path 14 (FIG. 5) for the vehicle 10 to achieve the navigation goal 40. In particular, as also set forth in more detail below, the instruction set may include a planning module configured for planning the lane-level path 14 to achieve the navigation goal 40 in an existence of the at least one uncertainty without access to a high-definition map of the plurality of potential paths 32.

In addition, although not shown in detail, the vehicle 10 may include a communications bus configured for enabling electronic communication between components of the vehicle 10. The motive power source 18 and vehicle 10 may include sensors, and the sensors, the onboard controller 28, and the motive power source 18, may be electrically connected to the communication bus and may transmit data and computerized commands therethrough to execute the aspects of the method 12, 112.

### Generating the Plurality of Potential Paths

Referring again to FIG. 2, the method 12 of planning the lane-level path 14 for the vehicle 10 includes generating 30 the plurality of potential paths 32 (FIG. 5) for the vehicle 10 according to the navigation goal 40 (FIG. 4). The vehicle 10 or planning module may receive the navigation goal 40 as an input from a user or from a navigation system of the vehicle 10. As described with reference to FIG. 4, a non-limiting example of the navigation goal 40 for the vehicle 10 may be to turn right at an intersection 42 in 150 meters. The method 12 then includes developing or generating 30 each of the plurality of potential paths 32 or plans for the vehicle 10 towards or in furtherance of the navigation goal 40.

In particular, as described with reference to FIGS. 4 and 5, generating 30 the plurality of potential paths 32 may include analyzing a scene of travel 16 (FIG. 4) generated by the vehicle 10. That is, during travel, the vehicle 10 may scan or monitor the scene of travel 16 with a plurality of on-board vehicle sensors, such as passive or active sensors including cameras, LiDAR, radar, and the like. Since the scene of travel 16 may be analyzed on-the-fly as the vehicle 10 travels, the scene of travel 16 may have less detail and precision than a high-definition map and may therefore include at least one uncertainty.

By way of non-limiting examples, the scene of travel 16 may include at least one uncertainty selected from a vehicle maneuver type, a lane intersection type, and a lane edge type. That is, although other uncertainties may exist, the scene of travel 16 may include uncertainty or lack of confidence with respect to, for example, which lane to traverse, whether a solid or dashed lane marking exists between two adjacent lanes, whether a lane exists, whether a lane permits turning, whether the intersection 42 is controlled by a traffic signal or a sign, whether the intersection 42 is uncontrolled, and the like.

As described with continued reference to FIG. 4, several potential lanes of travel are denoted as lane 1 (L1), lane 2 (L2), lane 3 (L3), etc. When the vehicle 10 is traveling in lane 1 (L1) as shown, there may be uncertainty or lack of confidence regarding a next maneuver allowed for the vehicle 10. That is, as shown, the vehicle 10 may be allowed or permitted to continue straight in lane 1 (L1), or may be allowed to continue straight and turn right using lane 8 (L8) to advance to lane 10 (L10). Similarly, when the vehicle 10 is traveling in lane 4 (L4), there may be uncertainty regarding the next allowed maneuver for the vehicle 10. That is, the vehicle may be allowed to continue straight in lane 4 (L4), may be allowed to continue straight and turn right using lane 7 (L7) to advance to lane 9 (L9), or may be allowed to turn right.

Likewise, uncertainty may exist with respect to intersection type for the intersection 42 denoted at lanes 2 (L2), 5 (L5), 7 (L7), and 8 (L8), i.e., the intersection 42 before lanes 3 (L3) and 6 (L6). For example, the intersection 42 may be controlled by a traffic signal; may be uncontrolled, yet include a stop sign; or may be uncontrolled, yet include a yield sign.

Further, uncertainty may exist with respect to lane edge type for adjacent lanes 1 (L1) and 4 (L4). For example, depending on local traffic laws and lane marking specifications, lanes 1 (L1) and 4 (L4) may be separated by a dashed line, a single solid line, or a double solid line.

Therefore, to account for such uncertainties, and described with continued reference to FIG. 4, generating 30 (FIG. 2) the plurality of potential paths 32 for the vehicle 10 may include specifying a sequence of one or more travel lanes for the vehicle 10 configured to achieve the navigation goal 40. That is, each of the plurality of potential paths 32 includes a sequence of lane maneuvers for the vehicle 10. Stated differently, the plurality of potential paths 32 may be lane-level paths or plans to achieve the navigation goal 40.

In one embodiment described with reference to FIG. 3, the method 112 may include developing 44 an online map 46 (FIG. 4) from inputs received from the plurality of on-board vehicle sensors. That is, as shown in FIG. 4, the online map 46 may summarize the available potential paths 32 and the interconnections between the plurality of potential paths 32. Stated differently, the online map 46 may provide the lanes, lane connections, and attributes for planning the lane-level path 14 and may provide a starting point to determine the possible ways to reach the navigation goal 40 given the scene of travel 16 and the inherent uncertainty.

Further, developing 44 the online map 46 may include creating a scene graph 48 (FIG. 5) from the scene of travel 16 (FIG. 4). That is, for the scene graph 48, each lane may be depicted as a node and each lane maneuver may be depicted as a connection or branch between nodes. Since the online map 46 may also be developed on-the-fly as the vehicle 10 travels, the online map 46 may have less detail and precision than a high-definition map and may therefore include the at least one uncertainty. For example, the online map 46 may also include at least one uncertainty with respect to the vehicle maneuver type, the lane intersection type, and the lane edge type.

In one non-limiting example, generating 30 the plurality of potential paths 32 may include searching the scene graph 48 using a depth-first search algorithm. That is, each of the plurality of potential paths 32 may be generated by using a depth-first search algorithm. For example, the depth-first search algorithm may be a recursive algorithm that traverses or searches the scene graph 48 by starting at a root node and exploring each branch as far as possible before backtracking to thereby generate 30 the plurality of potential paths 32 including the sequence of lane maneuvers according to the navigation goal 40. For example, for the vehicle 10 traveling in lane 1 (L1) of FIG. 4 to achieve the navigation goal 40 of turning right in 150 meters, the plurality of potential paths 32 or plans may include:

### (I) Potential Path or Plan 1: L1→L8→L10

Potential Path or Plan 2: L1→L4→L7→L9

### Producing the Plurality of Proposed Task Lists

Referring again to FIG. 2, the method 12 also includes producing 34 the plurality of proposed task lists for each of the plurality of potential paths 32 based on at least one uncertainty with respect to the sequence of lane maneuvers. That is, producing 34 the plurality of proposed task lists may include listing a plurality of sequential vehicle maneuvers configured to accomplish each of the plurality of potential paths 32. More specifically, producing 34 the plurality of proposed task lists may include stepwise evaluating each of the plurality of potential paths 32 and listing the plurality of sequential vehicle maneuvers configured to accomplish each of the plurality of potential paths 32. For example, a new scene graph 48 may be generated and traversed to generate the plurality of proposed task lists for each of the plurality of potential paths 32, as set forth in more detail below.

Further, producing 34 the plurality of proposed task lists may include listing both a viable proposed task list that enables reaching the navigation goal 40 and a non-viable proposed task list that does not enable reaching the navigation goal 40. For example, a viable proposed task list may enable the vehicle 10 to continue toward the navigation goal 40. In contrast, a non-viable proposed task list may result in a dead-end of travel for the vehicle 10.

As such, the plurality of proposed tasks lists may be a plurality of hypotheses that include specific tasks or maneuvers for the vehicle 10. As a non-limiting example, for the plurality of potential paths 32 set forth above at (I), the method 12 may include producing 34 the following proposed task lists for each of the plurality of potential paths 32 for the vehicle 10 positioned in lane 1 (L1) of FIG. 4 for the navigation goal 40 of turning right at the intersection 42 in 150 meters:

### (II) Potential Path or Plan 1: L1→L8→L10

### Task List or Hypothesis 1—Viable

1. Follow lane
2. Stop for traffic light
3. Turn right at intersection

### Task List or Hypothesis 2—Dead-End or not Viable

1. Follow lane
2. Stop for traffic light
3. No right connection

### Potential Path or Plan 2: L1→L4→L7→L9

### Task List or Hypothesis 1—Viable

1. Lane change right
2. Stop for traffic light
3. Turn right at intersection

### Task List or Hypothesis 2—Dead-End or not Viable

1. Follow lane
2. No lane change possible

### Task List or Hypothesis 3—Viable

1. Lane change left
2. Stop for stop sign
3. Turn right at intersection

### Task List or Hypothesis 4—Dead-End or not Viable

1. Lane change left
2. Stop for traffic light
3. No right connection

### Probability of Occurrence

In addition, producing 34 the plurality of proposed task lists may include assigning a probability (p) of occurrence to each of the plurality of sequential vehicle maneuvers. That is, each of the plurality of sequential vehicle maneuvers of each task list may not have the same likelihood of occurring. For example, it may be more likely that the vehicle 10 positioned in lane 1 (L1) of FIG. 4 may change lanes to lane 4 (L4) before turning right than remain in lane 1 (L1) before turning right. That is, the lane change from lane 1 (L1) to lane 4 (L4) may have a higher probability (p) of occurrence than remaining in lane 1 (L1).

That is, the assigned probability (p) relates to a confidence value for a corresponding element of the scene graph 48. For example, as described with continued reference to FIG. 4, a vehicle maneuver such as “Turn right at intersection” may have a probability (p) of 0.2 because turn lane 8 (L8) in the scene graph 48 may have an existence confidence, i.e., a confidence that turn lane 8 (L8) actually exists, of 0.2. In other words, the probability (p) may be derived from scene uncertainties of the scene graph 48. As such, a non-limiting example of assigned probabilities (p) of occurrence for the task lists set forth at (II) may include:

### (III) Potential Path or Plan 1: L1→L8→L10

### Task List or Hypothesis 1—Viable

1. Follow lane (p=1)
2. Stop for traffic light (p=1)
3. Turn right at intersection (p=0.2)

### Task List or Hypothesis 2—Dead-End or not Viable

1. Follow lane (p=1)
2. Stop for traffic light (p=1)
3. No right connection (p=0.8)

### Potential Path or Plan 2: L1→L4→L7→L9

### Task List or Hypothesis 1—Viable

1. Lane change right (p=0.8)
2. Stop for traffic light (p=0.9)
3. Turn right at intersection (p=0.9)

### Task List or Hypothesis 2—Dead-End or not Viable

1. Follow lane (p=0.2)
2. No lane change possible

### Task List or Hypothesis 3—Viable

1. Lane change left (p=0.8)
2. Stop for stop sign (p=0.1)
3. Turn right at intersection (p=0.9)

### Task List or Hypothesis 4—Dead-End or not Viable

1. Lane change left (p=0.8)
2. Stop for traffic light (p=0.9)
3. No right connection (p=0.1)

### Overall Probability

Further, producing 34 the plurality of proposed task lists may include assigning an overall probability (P) to each of the plurality of proposed task lists based on the probability (p) of occurrence of each of the plurality of sequential vehicle maneuvers. That is, the overall probability (P) may be calculated by multiplying together the probabilities (p) of occurrence for each respective sequential vehicle maneuver. For example, an overall probability (P) for task list 1 of potential path or plan 1 may be equal to p1×p2×p3=1×1×0.2=0.2. As such, a non-limiting example of assigned overall probabilities (P) for each of the proposed task lists set forth at (III) may include:

### (IV) Potential Path or Plan 1: L1→L8→L10

### Task List or Hypothesis 1 (P=0.2)—Viable

1. Follow lane (p=1)
2. Stop for traffic light (p=1)
3. Turn right at intersection (p=0.2)

### Task List or Hypothesis 2 (P=0.8)—Dead-End or not Viable

1. Follow lane (p=1)
2. Stop for traffic light (p=1)
3. No right connection (p=0.8)

### Potential Path or Plan 2: L1→L4→L7→L9

### Task List or Hypothesis 1 (P=0.65)—Viable

1. Lane change right (p=0.8)
2. Stop for traffic light (p=0.9)
3. Turn right at intersection (p=0.9)

### Task List or Hypothesis 2 (P=0.2)—Dead-End or not Viable

1. Follow lane (p=0.2)
2. No lane change possible

### Task List or Hypothesis 3 (P=0.07)—Viable

1. Lane change left (p=0.8)
2. Stop for stop sign (p=0.1)
3. Turn right at intersection (p=0.9)

### Task List or Hypothesis 4 (P=0.07)—Dead-End or not Viable

1. Lane change left (p=0.8)
2. Stop for traffic light (p=0.9)
3. No right connection (p=0.1)

### Determining the Utility Factor

Referring again to FIG. 2, the method 12 further includes determining 36 the utility factor (u) for each of the plurality of proposed task lists. The utility factor (u) may be a reward factor or opposite of a cost factor and may assist in weighing a favorability of each of the plurality of proposed task lists. A comparatively higher utility factor (u) may indicate a better chance of the vehicle 10 reaching a target lane or maneuver. For example, determining 36 the utility factor (u) may include considering one or more of an estimated time to complete each of the plurality of proposed task lists; a complexity of each of the plurality of proposed task lists; an estimated traffic congestion while completing each of the plurality of proposed task lists; and a risk factor associated with completing each of the plurality of proposed task lists.

For example, considering the estimated time to complete each of the plurality of proposed task lists may include calculating an estimated time to complete each task list to provide a time component, normalizing the time component, and multiplying the time component by a time coefficient. Similarly, considering the complexity of each of the plurality of proposed task lists may include calculating a maneuver complexity for each task list to provide a complexity component, normalizing the complexity component, and multiplying the complexity component by a complexity coefficient. Likewise, considering the estimated traffic congestion while completing each of the plurality of proposed task lists may include calculating a traffic congestion estimate for each task list to provide a congestion component, normalizing the congestion component, and multiplying the congestion component by a congestion coefficient.

Further, considering the risk factor associated with completing each of the plurality of proposed task lists may include, by way of non-limiting examples, assessing whether the vehicle 10 crosses a road boundary while completing each of the plurality of proposed task lists; whether the vehicle 10 violates a traffic control device while completing each of the plurality of proposed task lists; whether the vehicle 10 violates a turn lane while completing each of the plurality of proposed task lists; whether the vehicle 10 reaches an end of lane while completing each of the plurality of proposed task lists; and whether the vehicle 10 violates a lane marking while completing each of the plurality of proposed task lists. That is, considering the risk factor may assist in determining a suitability of each of the plurality of proposed task lists.

By way of a non-limiting example, for a task list that includes changing lanes across a dashed lane marking, the risk factor may be low and the utility factor (u) may be assigned a positive value, e.g., 5. However, for a task list that includes crossing a solid lane marking, the risk factor may be increased to medium and the utility factor (u) may be assigned a negative value, e.g., −2, to penalize the task list. Alternatively, for a task list that includes changing lanes across a double-solid lane marking where lane changes are not permissible, the risk factor may be further increased to high and the utility factor (u) may be assigned a comparatively higher negative value, e.g., −3, to further increase the penalty associated with the task list.

Therefore, as a non-liming example, each task list set forth at (IV) may include the utility factor (u) such as:

### (V) Potential Path or Plan 1: L1→L8→L10

Task List or Hypothesis 1 (P=0.2; u=3)—Viable
1. Follow lane (p=1)
2. Stop for traffic light (p=1)
3. Turn right at intersection (p=0.2)
   Task List or Hypothesis 2 (P=0.8; u=−2)—Dead-End or not Viable
1. Follow lane (p=1)
2. Stop for traffic light (p=1)
3. No right connection (p=0.8)

### Potential Path or Plan 2: L1→L4→L7→L9

Task List or Hypothesis 1 (P=0.65; u=6)—Viable
1. Lane change right (p=0.8)
2. Stop for traffic light (p=0.9)
3. Turn right at intersection (p=0.9)
   Task List or Hypothesis 2 (P=0.2; u=−2)—Dead-End or not Viable
1. Follow lane (p=0.2)
2. No lane change possible
   Task List or Hypothesis 3 (P=0.07; u=4)—Viable
1. Lane change left (p=0.8)
2. Stop for stop sign (p=0.1)
3. Turn right at intersection (p=0.9)
   Task List or Hypothesis 4 (P=0.07; u=−1)—Dead-end or Not Viable
1. Lane change left (p=0.8)
2. Stop for traffic light (p=0.9)
3. No right connection (p=0.1)

### Expected Utility

Referring again to FIG. 2, the method 12 may further include determining 136 an expected utility (U) for each of the plurality of potential paths 32 based on the overall probability (P) for each task list and the utility factor (u) for each task list. That is, the expected utility (U) may be the sum of products of the overall probability (P) of each task list and the utility (u) of each task list. For the example set forth at (V) above, the expected utility (U) for each of the plurality of potential paths 32 may be calculated as follows:

### (VI) Potential Path or Plan 1:

$$U = \sum {P}_{i} {u}_{i} = [ ( 0.2 \times 3 ) + ( 0.8 \times - 2 ) ] = - 1$$

Potential Path or Plan 2:

$$U = \sum {P}_{i} {u}_{i} = [ ( 0.65 \times 6 ) + ( 0.2 \times - 2 ) + ( 0.07 \times 4 ) + ( 0.07 \times - 1 ) ] = 1.45$$

### Selecting the Optimal Path and Task List

Referring again to FIG. 2, the method 12 also includes selecting 38 an optimal path from the plurality of potential paths 32 and an optimal task list from the plurality of proposed task lists to thereby plan the lane-level path 14 for the vehicle 10 to achieve the navigation goal 40. That is, selecting 38 the optimal path may include choosing one of the plurality of potential paths 32 having the highest expected utility (U), and selecting 38 the optimal task list may include choosing one of the plurality of proposed task lists having the highest utility factor (u). For example, the von Neumann-Morgenstern utility theorem may be used to choose or select the optimal potential path 32 and proposed task list. Therefore, for the non-limiting example set forth above at (VI), potential path or plan 2 has the highest expected utility (U), i.e., 1.45>−1, and task list or hypothesis 1 has the highest utility factor (u), i.e., 6>−2, 6>4, and 6>−1. As such, in this example, the method 12 may include selecting 38 potential path 2 and task list 1 to thereby plan the lane-level path 14 for the vehicle 10 to achieve the navigation goal 40.

In addition, as described with reference to FIG. 3, the method 112 may further include automatedly or autonomously controlling 50 the vehicle 10 along the lane-level path 14. That is, the onboard controller 28 may receive and execute instructions to automatedly traverse the vehicle 10 along the lane-level path 14, e.g., control the vehicle 10 to move from lane 1 (L1) to lane 4 (L4) to lane 7 (L7) to lane 9 (L9) by changing lanes to the right, stopping for the traffic light, and turning right at the intersection 42 to achieve the navigation goal 40, even in the presence of uncertainty in the scene of travel 16.

Therefore, in summary, the method 12, 112 may be a stochastic, utility-based planning approach to generate an optimal lane-level path 32 and tasks to reach the navigation goal 40 while accounting for uncertainty in the scene of travel 16 and probabilities (p) of occurrence. As such, the method 12, 112 and vehicle 10 may enable automated or autonomous driving without reliance upon high-definition maps. That is, the method 12, 112 may advantageously and precisely plan the lane-level path 14 for the vehicle 10 even with the existence of uncertainty in the scene of travel 16 and even in the absence of a high-definition map of the scene of travel 16. Further, the method 12, 112 may not suffer from explainability or behavior issues, e.g., how and why the method 12, 112 develops the lane-level path 14, but may instead provide a methodical, logical lane-level path 14 for the vehicle 10 based on the scene of travel 16.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of planning a lane-level path for a vehicle, the method comprising:
generating a plurality of potential paths for the vehicle according to a navigation goal, wherein each of the plurality of potential paths includes a sequence of lane maneuvers for the vehicle;
producing a plurality of proposed task lists for each of the plurality of potential paths based on at least one uncertainty with respect to the sequence of lane maneuvers;
determining a utility factor for each of the plurality of proposed task lists; and
selecting an optimal path from the plurality of potential paths and an optimal task list from the plurality of proposed task lists to thereby plan the lane-level path for the vehicle to achieve the navigation goal.

2. The method of claim 1, wherein generating the plurality of potential paths includes analyzing a scene of travel generated by the vehicle, wherein the scene of travel includes the at least one uncertainty selected from a vehicle maneuver type, a lane intersection type, and a lane edge type.

3. The method of claim 1, wherein generating the plurality of potential paths includes specifying a sequence of one or more travel lanes for the vehicle configured to achieve the navigation goal.

4. The method of claim 1, wherein producing the plurality of proposed task lists includes listing a plurality of sequential vehicle maneuvers configured to accomplish each of the plurality of potential paths.

5. The method of claim 4, wherein producing the plurality of proposed task lists includes assigning a probability of occurrence to each of the plurality of sequential vehicle maneuvers.

6. The method of claim 5, wherein producing the plurality of proposed task lists includes assigning an overall probability to each of the plurality of proposed task lists based on the probability of occurrence of each of the plurality of sequential vehicle maneuvers.

7. The method of claim 6, further including determining an expected utility for each of the plurality of potential paths based on the overall probability and the utility factor.

8. The method of claim 7, wherein selecting the optimal path includes choosing one of the plurality of potential paths having the highest expected utility; and
wherein selecting the optimal task list includes choosing one of the plurality of proposed task lists having the highest utility factor.

9. The method of claim 1, wherein determining the utility factor includes considering one or more of an estimated time to complete each of the plurality of proposed task lists, a complexity of each of the plurality of proposed task lists, an estimated traffic congestion while completing each of the plurality of proposed task lists, and a risk factor associated with completing each of the plurality of proposed task lists.

10. The method of claim 9, wherein considering the risk factor includes assessing whether the vehicle crosses a road boundary while completing each of the plurality of proposed task lists, whether the vehicle violates a traffic control device while completing each of the plurality of proposed task lists, whether the vehicle violates a turn lane while completing each of the plurality of proposed task lists, whether the vehicle reaches an end of lane while completing each of the plurality of proposed task lists, and whether the vehicle violates a lane marking while completing each of the plurality of proposed task lists.

11. A method of planning a lane-level path for a vehicle, the method comprising:
developing an online map from inputs received from a plurality of on-board vehicle sensors, wherein the online map includes a scene of travel for the vehicle having at least one uncertainty selected from a vehicle maneuver type, a lane intersection type, and a lane edge type;
generating a plurality of potential paths for the vehicle according to a navigation goal, wherein each of the plurality of potential paths includes a sequence of lane maneuvers for the vehicle;
producing a plurality of proposed task lists for each of the plurality of potential paths based on the at least one uncertainty;
determining a utility factor for each of the plurality of proposed task lists; and
selecting an optimal path from the plurality of potential paths and an optimal task list from the plurality of proposed task lists to thereby plan the lane-level path for the vehicle to achieve the navigation goal.

12. The method of claim 11, wherein developing the online map includes creating a scene graph from the scene of travel.

13. The method of claim 12, wherein generating the plurality of potential paths includes searching the scene graph using a depth-first search algorithm.

14. The method of claim 11, wherein producing the plurality of proposed task lists includes stepwise evaluating each of the plurality of potential paths and listing a plurality of sequential vehicle maneuvers configured to accomplish each of the plurality of potential paths.

15. The method of claim 11, wherein producing the plurality of proposed task lists includes listing both a viable proposed task list that enables reaching the navigation goal and a non-viable proposed task list that does not enable reaching the navigation goal.

16. The method of claim 11, wherein determining the utility factor includes considering a risk factor associated with completing each of the plurality of proposed task lists, wherein the risk factor includes whether the vehicle crosses a road boundary while completing each of the plurality of proposed task lists, whether the vehicle violates a traffic control device while completing each of the plurality of proposed task lists, whether the vehicle violates a turn lane while completing each of the plurality of proposed task lists, whether the vehicle reaches an end of lane while completing each of the plurality of proposed task lists, and whether the vehicle violates a lane marking while completing each of the plurality of proposed task lists.

17. The method of claim 11, further including automatedly controlling the vehicle along the lane-level path.

18. A vehicle comprising:
a plurality of wheels configured to translate along a lane-level path;
a motive power source configured to drive the plurality of wheels; and
an onboard controller in communication with the motive power source and including an instruction set that is executable to:
generate a plurality of potential paths for the vehicle according to a navigation goal, wherein each of the plurality of potential paths includes a sequence of lane maneuvers for the vehicle;
produce a plurality of proposed task lists for each of the plurality of potential paths based on at least one uncertainty with respect to the sequence of lane maneuvers;
determine a utility factor for each of the plurality of proposed task lists; and
select an optimal path from the plurality of potential paths and an optimal task list from the plurality of proposed task lists to thereby plan the lane-level path for the vehicle to achieve the navigation goal.

19. The vehicle of claim 18, wherein the instruction set includes a planning module configured for planning the lane-level path to achieve the navigation goal in an existence of the at least one uncertainty without access to a high-definition map of the plurality of potential paths.

20. The vehicle of claim 18, wherein the onboard controller is configured for automatedly controlling the motive power source.
